(19) United States
(12) Patent Application Publication
(10) Pub. No.: US 2022/0064387 A1
(43) Pub. Date: Mar. 3, 2022

(54) COMPOSITE FILM AND METHOD FOR PREPARING THE SAME

(71) Applicants: Hyundai Motor Company, Seoul (KR); Kia Motors Corporation, Seoul (KR); Korea Research Institute Of Chemical Technology, Daejeon (KR)

(72) Inventors: Chae Hwan Hong, Seoul (KR); Jin Woo Choung, Suwon (KR); Dong Yeop Oh, Busan (KR); Seul A Park, Ulsan (KR); Hyeon Yeol Jeon, Seoul (KR); Jeyoung Park, Ulsan (KR); Sung Yeon Hwang, Seoul (KR)

(21) Appl. No.: 17/082,207

(22) Filed: Oct. 28, 2020

(30) Foreign Application Priority Data
Aug. 25, 2020 (KR) 10-2020-0106846

(51) Int. Cl. C08J 5/18

(52) U.S. Cl. CPC C08J 5/18; C08J 2469/00; C08J 2301/02

(57) ABSTRACT

Disclosed is a composite film including a nanocellulose film including cellulose nanofibers stacked in a structure including a plurality of pores; and a polycarbonate resin filling the pores in the nanocellulose film and including a repeating unit that comprises a moiety derived from isosorbide.

### CROSS-REFERENCE TO RELATED APPLICATION

This application claims priority to and benefits of Korean Patent Application No. 10-2020-0106846 filed in the Korean Intellectual Property Office on Aug. 25, 2020, the entire contents of which are incorporated herein by reference.

### TECHNICAL FIELD

The present invention relates to a composite film and a preparing method thereof. The composite film may include an isosorbide-based polycarbonate resin and nanocellulose impregnated with the polycarbonate resin.

### BACKGROUND

Polycarbonate is a transparent plastic with excellent mechanical and thermal characteristics, and has been widely used in food and beverage packaging, compact disks, the medical field, electronic devices, and sports equipment. Bisphenol-A (BPA), which a main raw material of polycarbonate, is a key diol monomer that improves the mechanical and thermal characteristics and transparency of plastics due to polymer rigidity and a distorted molecular structure. However, since the BPA may act as an endocrine disruptor to cause developmental and reproductive problems in humans, BPA-based polycarbonate has recently been banned from use in children's products and beverage and food packaging.

Deionhydro-D-glucitol (1,4:3,6-Dianhydro-D-glucitol), which can be produced from biomass and is known as isosorbide (ISB), is a double-ring monosaccharide derivative.

The above information disclosed in this Background section is only for enhancement of understanding of the background of the invention, and therefore it may contain information that does not form the prior art that is already known in this country to a person of ordinary skill in the art.

### SUMMARY OF THE INVENTION

In preferred aspects, provided is a composite film capable of implementing a low coefficient of thermal expansion while maintaining high light transmittance and improving physical properties through a low difference in interfacial energy between composite materials and a preparing method of the composite film.

In an aspect, provided is a composite film that that may include: a film member including a porous film preferably a nanocellulose film including cellulose nanofibers; and polycarbonate resin that comprises moieties derived from a diol particularly isosorbide moieties such as including a repeating unit that comprises a structures of Chemical Formula 1.

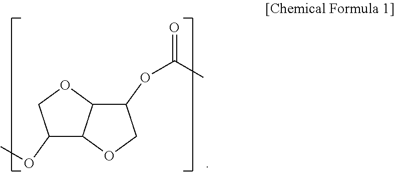

In particular, the cellulose nanofibers may be stacked to form a structure including a plurality of pores and the polycarbonate may fill the pores.

The stacked cellulose nanofibers may form a porous structure. The “porous structure” as used herein may include plurality of shapes of pores (e.g., circular, or non-circular), holes, cavity (e.g., microcavity), labyrinth, channel or the like, whether formed uniformly or without regularity, which may be formed between the nanofibers and/or may exist internal spaces in the nanofibers. Exemplary porous structure may include pores (e.g., closed or open pores) within a predetermined size within a range from sub-micrometer to micrometer size, which is measured by maximum diameter of the pores.

The composite film may include the nanocellulose film in an amount of about 10 wt % or greater with respect to a total weight of the composite film.

The cellulose nanofibers may have an average diameter of about 2 nm to 200 nm, and an average length of about 100 nm to 100 μm.

The polycarbonate resin may suitably include the repeating unit of Chemical Formula 1 in an amount of about 50 wt % to 90 wt % with respect to a total weight of the polycarbonate.

The polycarbonate may further include a repeating unit that comprises moieties derived from a diol moieties such as of Chemical Formula 2:

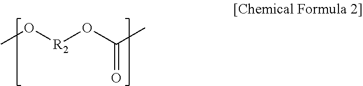

wherein, in Chemical Formula 2, R₂ is a C3 to C20 alkylene group.

The polycarbonate resin may include the repeating unit of Chemical Formula 1 and the repeating unit of Chemical Formula 2 in a weight ratio of about 50:50 to 90:10.

The composite film may have a coefficient of thermal expansion of about 50 ppm/K or less under a condition of a thickness of 100 μm.

The composite film may have light transmittance of about 30% or greater under a light irradiation condition of 550 nm when a thickness is 100 μm.

In an aspect, provided is a preparing method of a composite film. The method may include: preparing a polycarbonate solution including polycarbonate including a repeating unit of Chemical Formula 1 described above and a solvent; and filling the polycarbonate solution into pores of a nanocellulose film in which cellulose nanofibers are stacked in a structure including a plurality of pores.

The solvent may suitably include dimethylacetamide (DMAc).

In the filling the polycarbonate solution in the pores, the nanocellulose film may be impregnation with the polycarbonate solution.

According to various exemplary embodiments of the present invention, the composite film may implement a low coefficient of thermal expansion while maintaining high light transmittance and improving physical properties through a low difference in interfacial energy between composite materials.

Accordingly, the composite film may be applied to a substrate of a flexible display, and the like, thereby reducing a cost thereof and improving quality, and may be applied to a window film, a laminating film, a furniture film, a cover film, a microscope slide film, a cover glass replacement film, or a protective film as well as a glass screen protector, and the like, which suppresses display optical glass damage caused by impact of small IT devices.

The isosorbide structures (including groups of Chemical Formula I) may have any geometric or stereochemical configuration.

Other aspects of the invention are disclosed infra.

### BRIEF DESCRIPTION OF THE DRAWING

FIG. 1 shows an exemplary preparing process of a composite film according to an exemplary embodiment of the present invention.

### DETAILED DESCRIPTION

The advantages and features of the present invention and the methods for accomplishing the same will be apparent from the exemplary embodiments described hereinafter with reference to the accompanying drawings. However, an implemented form may not be limited to exemplary embodiments disclosed below. Unless otherwise defined, all terms (including technical and scientific terms) used herein have the same meaning as commonly understood by one of ordinary skill in the art. In addition, terms defined in a commonly used dictionary are not to be ideally or excessively interpreted unless explicitly defined.

In addition, throughout the specification unless explicitly described to the contrary, the word “comprise” and variations such as “comprises” or “comprising” will be understood to imply the inclusion of stated elements but not the exclusion of any other elements.

In the present specification, “alkylene” refers to a divalent organic radical having two bonding positions derived from a linear or branched hydrocarbon having 1 to 20 carbon atoms. As an example, a C 1 to C 20 aliphatic alkylene, a C 3 to C 20 alicyclic alkylene, or a combination thereof may be included.

The “alicyclic alkylene” refers to a divalent organic radical having two bonding positions derived from a saturated hydrocarbon containing a ring having 3 to 20 carbon atoms.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

In an aspect, provided is a composite film including a nanocellulose film and a polycarbonate resin filling pores of the nanocellulose film.

The nanocellulose film may be a film in which cellulose nanofibers are stacked to form a structure including a plurality of pores.

The term “cellulose nanofiber(s)” as used herein refer to nano/micrometer-sized fibers (cellulose nanofibril (CNF)) in which cellulose chains form a bundle to be bundled. The cellulose nanofibers may have an average diameter of about 2 nm to 200 nm and an average length of about 100 nm to 100 e.g., an average diameter of about 5 nm to 100 nm and an average length of about 500 nm to 10 When the average diameter of the cellulose nanofibers is less than about 2 nm, it may be difficult for a polymer to penetrate into an empty space of the nanocellulose film, and when it is greater than about 2 nm, spatial separation between the nanocellulose and the polymer may increase, thereby deteriorating transmittance. In addition, when the average length of the cellulose nanofibers is less than 100 nm, a composite film may not be formed, and when it is greater than about 100 μm, processability may be deteriorated.

The composite film may suitably include nanocellulose film in an amount of about 10 wt % or greater, e.g., about 10 wt % to 95 wt % or about 15 wt % to 90 wt %, with respect to a total weight of the composite film. When a content of the nanocellulose film is less than about 10 wt %, a coefficient of thermal expansion may increase.

The polycarbonate resin may fill the pores of the nanocellulose film.

The composite film may further include a thin polycarbonate layer on one surface or opposite surfaces of the nanocellulose film. The polycarbonate layer may be formed by forming a thin film on the surface of the nanocellulose film by remaining polycarbonate after the polycarbonate fills the pores of the nanocellulose film.

The polycarbonate may include a repeating unit (A) that comprises moieties derived from a diol particularly isosorbide moieties such as those comprises a structure of Chemical Formula 1,

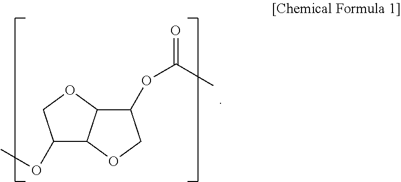

Accordingly, the polycarbonate may not contain a repeating unit derived from bisphenol-A (BPA).

The polycarbonate resin may include the isosorbide-derived repeating unit in an amount of about 50 wt % to 90 wt %, e.g., about 60 wt % to 85 wt %, with respect to a total weight of the polycarbonate. When a content of the isosorbide-derived repeating unit is less than about 50 wt %, miscibility with the nanocellulose may be poor or thermal stability may be poor, and when it is greater than about 90 wt %, the film may be hardened or processability may be deteriorated.

The polycarbonate resin may be a homopolymer including only the isosorbide-derived repeating unit (A), or a copolymer further including a diol-derived repeating unit (B) including an additional carbonate group (—O(C═O)O—).

For example, the polycarbonate resin may be a copolymer further including the isosorbide-derived repeating unit (A), and a diol-derived repeating unit (B) including a carbonate group containing an aliphatic group (—R₁—O(C═O)O—, R₁ being a C1 to C20 aliphatic alkylene group) or a carbonate group containing an alicyclic group (—R₂—O(C═O)O—, R₂ being a C3 to C20 alicyclic alkylene group).

For example, the diol-derived repeating unit (B) may be represented by Chemical Formula 2.

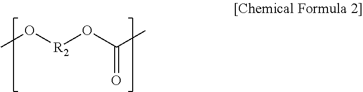

In Chemical Formula 2, R₂ may be a C3 to C20 alkylene group, e.g., may be a divalent substituent containing a C3 to C10 alicyclic alkylene group, or a divalent substituent formed of a combination of a C1 to C10 aliphatic alkylene group and a C3 to C10 alicyclic alkylene group.

For example, the diol-derived repeating unit represented by Chemical Formula 2 may be represented by Chemical Formula 3.

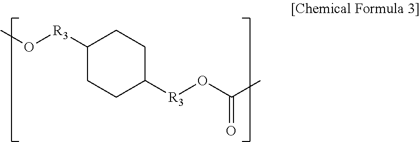

In Chemical Formula 3, R₃ may be a C1 to C10 alkylene group, e.g., a methylene group.

The polycarbonate resin may include the isosorbide-derived repeating unit (A) and the diol-derived repeating unit (B) in a weight ratio of about 50:50 to 90:10, e.g., in a weight ratio of about 60:40 to 85:15. When the weight ratio of the isosorbide-derived repeating unit is less than about 50, the miscibility with the nanocellulose may be poor or thermal stability may be poor, and when it is greater than about 90, the film may be hardened or the processability may be deteriorated.

The polycarbonate resin may have, e.g., a weight average molecular weight of about 10,000 g/mol to 200,000 g/mol, but the present invention is not limited thereto.

The polycarbonate resin including the isosorbide-derived repeating unit (A) may have greater hydrophilicity than that of petroleum bisphenol A-based polycarbonate, and have a less interfacial energy difference because it has a chemical structure that is similar to that of the cellulose nanofibers. Accordingly, the composite film may implement a low coefficient of thermal expansion while maintaining high light transmittance by complementing physical properties that each individual material does not have.

Thus, the composite film may have a coefficient of thermal expansion of about 50 ppm/K or less under a condition of a thickness of 100 μm, and it may be, e.g., about 1 ppm/K to 45 ppm/K. In addition, the composite film may have light transmittance of about 30% or greater under a light irradiation condition of 550 nm when a thickness of 100 μm, and it may be, e.g., about 35% to 99%.

In an aspect, provided is a method of preparing a composite film. The method may include preparing a polycarbonate solution including a polycarbonate resin including an isosorbide-derived repeating unit (A) in a solvent; and filling the polycarbonate solution into pores of a nanocellulose film in which cellulose nanofibers are stacked in a form including a plurality of pores. For example, the polycarbonate solution may be prepared by dissolving the polycarbonate resin into the solvent.

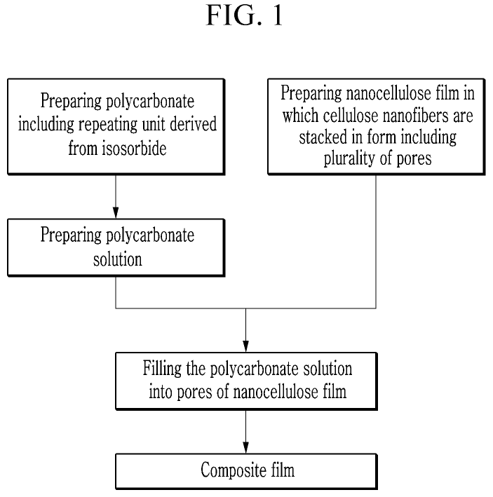

FIG. 1 shows an exemplary preparing process of an exemplary composite film according to an exemplary embodiment of the present invention. Hereinafter, the preparing method of the composite film will be described with reference to FIG. 1.

First, nanocellulose films in which polycarbonate resin containing an isosorbide-derived repeating unit (A) and cellulose nanofibers may be respectively stacked to form a structure including a plurality of pores are provided.

For example, the polycarbonate resin including the isosorbide-derived repeating unit (A) may be prepared by mixing isosorbide and diester carbonate, followed by polymerization.

The isosorbide may be obtained in a form of anhydrosugar alcohol through dehydration from hexitol, which is a representative substance of hydrogenated sugar, obtained by reducing a glucose isomer, which is a biomass.

The diester carbonate is not particularly limited as long as it is a substance used as a polycarbonate precursor, but may include any one or two or more selected from, e.g., an aromatic diester carbonate, an alicyclic diester carbonate, and an aliphatic diester carbonate. Specifically, it may include any one or more selected from diphenyl carbonate, ditolyl carbonate, bis(chlorophenyl) carbonate, m-cresyl carbonate, dinaphthyl carbonate, diethyl carbonate, dimethyl carbonate, dibutyl carbonate, dicyclohexyl carbonate, and the like. An aromatic carbonate diester such as diphenyl carbonate may suitably be selected, but the present invention is not limited thereto.

For example, the nanocellulose film may be prepared by performing nanoization on white pulp obtained from a plant resource such as conifers or hardwoods by a mechanical friction grinding method and the like to prepare a paste in a form of water dispersion, and by applying the paste to a flat mold and then drying it.

Next, a polycarbonate solution may be prepared by dissolving a polycarbonate containing an isosorbide-derived repeating unit (A) in a solvent.

The solvent may suitably include an aromatic solvent, e.g., an alcohol such as methanol, ethanol, propanol, butanol, or hexanol; an organic halogen solvent such as chloroform, dichloromethane, trichloromethane, tetrachloromethane, or trichloroethane; an ether such as dimethyl ether, diethyl ether, dipropyl ether, polyether, glycol ether, tetrahydrofuran, or dioxane; an ester such as a carboxylic ester, particularly methyl acetate, ethyl acetate, propyl acetate, butyl acetate, gamma-butyrolactone, gamma-valerolactone, carboxylic acid dimethyl ester, ethyl lactate, or cyclohexanol acetate; a ketone such as acetone, methyl ethyl ketone, or butyl methyl ketone; an aromatic solvent such as benzene, toluene, xylene, or ethylbenzene; or a deep eutectic solvent (DES) based on quaternary ammonium compounds and hydrogen bond donors such as choline chloride/urea, choline acetate/urea, tetrabutylammonium chloride/oxalic acid, or choline chloride/glycol, which are capable of dissolving the polycarbonate containing the isosorbide-derived repeating unit (A).

However, dimethylacetamide (DMAC, CH₃C(═O)N(CH₃)₂) may be suitably used alone as a solvent capable of dissolving the polycarbonate containing the isosorbide-derived repeating unit. The dimethylacetamide has a refractive index (nD) of 1.4375, is solubility in water (miscible), is a colorless liquid, and has a density of 0.937 g/mL. As such, the dimethylacetamide has high miscibility with water, has a specific gravity close to water compared to other petroleum solvents, and has a refractive index close to that of a nanocellulose film. Accordingly, even when a small amount of the dimethylacetamide is mixed in a final composite film after the polycarbonate solution is filled in the pores of the nanocellulose film, negative characteristics may not be provided to physical properties of the composite film.

The prepared composite film may contain a small amount of the dimethylacetamide, e.g., about 2 wt % or less, or 1 wt % or less. Even when the composite film contains a small amount of the dimethylacetamide, the physical properties of the composite film may not be affected.

The polycarbonate solution may be filled in the pores of the nanocellulose film, and then the solvent may be dried to prepare a flat composite film.

The polycarbonate solution may fill the pores of the nanocellulose film by supporting or impregnating the nanocellulose film in the polycarbonate solution, or coating the polycarbonate solution on the nanocellulose film by bar coating, comma coating, slot die coating, screen printing, spray coating, doctor blade coating, or lamination.

The drying conditions are not particularly limited as long as the solvent can be volatilized, e.g., the drying may be performed in a range of room temperature (about 20° C.) to about 250° C. under normal pressure or vacuum for about 1 h to 60 h.

According to an exemplary preparing method of the composite film, a composite film having a low coefficient of thermal expansion may be prepared while maintaining high light transmittance by dissolving the polycarbonate containing the isosorbide-derived repeating unit in an appropriate solvent and then impregnating it in the nanocellulose film.

Accordingly, the composite film may be applied to a substrate of a flexible display, and the like, thereby reducing a cost thereof and improving quality, and may be applied to a glass screen protector, and the like, which suppresses display optical glass damage caused by impact of small IT devices.

In addition, the composite film may be melted or heat treated, and then applied to a window film, a laminating film, a furniture film, a cover film, a microscope slide film, a cover glass replacement film, or a protective film, which can be adhered to glass, wood, metal, ceramic, or plastic.

### EXAMPLE

Hereinafter, specific examples of the invention are described. However, the examples described below are for illustrative purposes only, and the scope of the invention is not limited thereto.

### Preparing Example

### Synthesis Example 1: Synthesis of Polycarbonate Containing Repeating Unit Derived from Isosorbide

Isosorbide (29.81 g, 0.204 mol), 1,4-cyclohexanedimethanol (1,4-cyclohexanedimethanol, 12.61 g, 0.087 mol), diphenyl carbonate (62.43 g, 0.291 mol), and tetramethylammonium hydroxide (100 mg, 0.55 mmol) were added into a reactor, a temperature thereof was raised to a temperature of 150° C. to start polymerization, and mechanical stirring was performed under a nitrogen atmosphere for 2 h.

Next, a phenol by-product was removed under conditions at a temperature of 180° C. and at a pressure of 100 Torr for 1 h. Thereafter, the temperature was slowly raised to a temperature of 240° C., and a vacuum degree was lowered to a pressure of 0.1 mTorr or less. After 30 minutes, the reaction was stopped, and biopolycarbonate containing a repeating unit derived from isosorbide was obtained (Yield: 49 g, 98%, weight average molecular weight: 69,000 g/mol, mole fraction: n:m=0.7:0.3 (n=isosorbide, m=1,4-cyclohexanedimethanol)).

### Synthesis Example 2: Preparing of Nanocellulose Film

An appropriate amount of water-dispersed paste obtained by nanoization of white pulp by mechanical friction grinding (equipment: Japan, Masuko Sangyo Co, friction grinding machine, model name: MKZA10-15J) was applied to a flat mold, and then, only water was forcibly removed from the water dispersion paste applied to the mold by using a vacuum suction method from a lower end of a filter with micro-sized micropores, and thereafter, cellulose nanofibers remaining at an upper end of the filter were dried to prepare a 100 μm-thick nanocellulose film.

### Example 1: Preparing of Composite Film

A polycarbonate solution (polycarbonate content: 10 wt %) was prepared by dissolving the polycarbonate containing the isosorbide-derived repeating unit prepared in Synthesis Example 1 in a dimethylacetamide (DMAC, CH₃C(═O)N(CH₃)₂) solvent.

The composite film was prepared by sufficiently wetting the 100 μm-thick nanocellulose film prepared in Synthesis Example 2 using the polycarbonate solution, and then by drying it in an oven at a temperature of 80° C. for 12 h or longer.

### Comparative Example 1: Preparing of Composite Film

A polycarbonate solution (petroleum bisphenol A (BPA)-polycarbonate content: 10 wt %) was prepared by dissolving petroleum bisphenol A (BPA)-polycarbonate (manufacturer: Sigma Aldrich, number average molecular weight (Mw) 45,000 g/mol) in a dimethylacetamide (DMAc) solvent.

The composite film was prepared by sufficiently wetting the 100 μm-thick nanocellulose film prepared in Synthesis Example 2 using the polycarbonate solution, and then by drying it in an oven at room temperature.

The bisphenol A (BPA)-polycarbonate has a chemical structure as in Chemical Formula 4. It is a material that contains a benzene structure in a unit molecular structure and has very high lipophilicity.

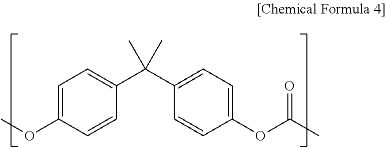

### Comparative Example 2: Preparing of Single-Layer Film

1 g of polycarbonate containing the isosorbide-derived repeating unit prepared in Synthesis Example 1 was mixed with 9 g of a dimethylacetamide (DMAc) solvent, and stirred at room temperature for 1 h to prepare a carbonate solution.

Thereafter, a 100 μm-thick film made of only polycarbonate containing the isosorbide-derived repeating unit was prepared by a solution casting method using the carbonate solution.

### Experimental Example: Measuring the Physical Properties of Prepared Composite Film

The light transmittance and the coefficient of thermal expansion of the films prepared in Example 1, Comparative Example 1, and Comparative Example 2 were measured by a following method, and results thereof are summarized in Table 1.
Light transmittance: Measured by UV/vis spectrometer UV-2600 made by SHIMADZU, and the transmittance at 550 nm is determined as a comparative value.
Coefficient of thermal expansion (CTE): Measured by a thermomechanical analyzer (TMA) made by TA Instruments at a probe force of 20 mN and a temperature increase rate of 10° C./min in a nitrogen environment, and a ppm/K value was calculated from an interval of 30° C. to 80° C. The coefficient of thermal expansion is measured in a straight line portion of a TMA measurement curve.
Content measurement of nanocellulose film: A content ratio of weight of the contained nanocellulose film to a total weight of the composite film is measured.

TABLE 1

| | | Coefficient of | Content of |
|---|---|---|---|
| | Light | thermal | nanocellulose film |
| | transmittance (%) | expansion (ppm/K) | (wt %) |
| Example 1 | 93 | 41 | 20 |
| Comparative | 30 | — | 20 |
| Example 1 | (Deviation in | (Measuring | |
| | measured value | impossibility, | |
| | being very large) | severe error) | |
| Comparative | 90 | 70 | 0 |
| Example 2 | | | |

As shown in Table 1, the composite film prepared in Comparative Example 1 had a large difference in interfacial energy between the bisphenol A (BPA)-polycarbonate and the nanocellulose film, thereby making it impossible to prepare a normal and reproducible transparent composite film. Further, since the quality of the final composite film was not uniform, reliable evaluation of the coefficient of thermal expansion was impossible, and low light transmittance was acquired. This result may be due to poor compatibility between cellulose nanofibers with hydroxyl groups on a surface thereof and the petroleum bisphenol A (BPA)-polycarbonate material.

In addition, the composite film prepared in Example 1 had superior light transmittance, and in particular, had a less thermal expansion coefficient than that of the film prepared in Comparative Example 2. This may be primarily because the coefficient of thermal expansion of the nanocellulose film was very low (about a 5 ppm/K level), but when the dispersion of the nanocellulose film and the polycarbonate was not effective, an effect of lowering the coefficient of thermal expansion of the prepared composite film may not be obtained. As shown in Example 1, the effect of lowering the coefficient of thermal expansion of the final composite film may be obtained only when the nanocellulose film and the polycarbonate are mixed and dispersed effectively.

On the other hand, in the case of the film prepared in Comparative Example 2, the thermal expansion coefficient was greater than that of the composite film prepared in Example 1, and a level of the value was similar to that of a general polymer material. Accordingly, as in the composite film prepared in Example 1, when the nanocellulose film and the polycarbonate containing the isosorbide-derived repeating unit were not combined, it is impossible to reduce the coefficient of thermal expansion.

While this invention has been described in connection with what is presently considered to be the exemplary embodiments, it is to be understood that the invention is not limited to the disclosed embodiments, but, on the contrary, is intended to cover various modifications and equivalent arrangements included within the spirit and scope greater than or equal to appended claims.

What is claimed is:

1. A composite film comprising:
a film comprising cellulose nanofibers; and
a polycarbonate resin comprising a repeating unit that comprises an isosorbide structure.

2. The film of claim 1 wherein the repeat unit comprises a structure of Chemical Formula 1:

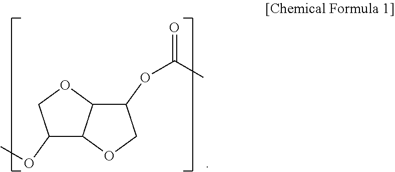

3. The composite film of claim 1, wherein the cellulose nanofibers are stacked to form a structure comprising a plurality of pores and the polycarbonate fills the pores.

4. The composite film of claim 1, wherein the composite film comprises the nanocellulose film in an amount of about 10 wt % or greater with respect to a total weight of the composite film.

5. The composite film of claim 1, wherein the cellulose nanofibers have an average diameter of about 2 nm to 200 nm, and an average length of about 100 nm to 100 μm.

6. The composite film of claim 1, wherein the polycarbonate resin comprises the repeating unit that comprises an isosorbide group in an amount of about 50 wt % to 90 wt % with respect to a total weight of the polycarbonate resin.

7. The composite film of claim 1, wherein the polycarbonate resin further comprising a repeating unit that comprises a diol structure or moiety derived from a diol.

8. The composite film of claim 1, wherein the polycarbonate resin further comprising a repeating unit of Chemical Formula 2: 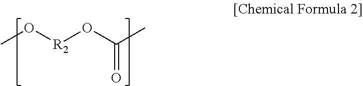
wherein, in Chemical Formula 2,
R₂ is a C3 to C20 alkylene group.

9. The composite film of claim 2, wherein the polycarbonate resin further comprising a repeating unit of Chemical Formula 2: 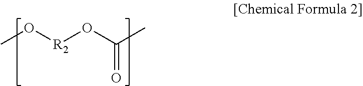
wherein, in Chemical Formula 2,
R₂ is a C3 to C20 alkylene group.

10. The composite film of claim 9, wherein the polycarbonate resin comprises the repeating unit of Chemical Formula 1 and the repeating unit of Chemical Formula 2 in a weight ratio of about 50:50 to 90:10.

11. The composite film of claim 1, wherein the composite film has a coefficient of thermal expansion of about 50 ppm/K or less under a condition of a thickness of 100 μm.

12. The composite film of claim 1, wherein the composite film has light transmittance of about 30% or greater under a light irradiation condition of 550 nm when a thickness is 100 μm.

13. A preparing method of a composite film, comprising:
preparing a polycarbonate solution comprising a polycarbonate resin comprising a repeating unit of Chemical Formula 1 and a solvent; and 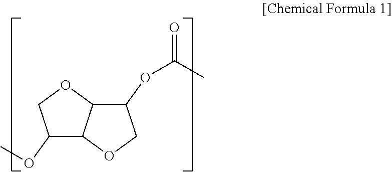
filling the polycarbonate solution into pores of a nanocellulose film comprising cellulose nanofibers wherein the cellulose nanofibers are stacked in a structure including a plurality of pores.

14. The preparing method of claim 13, wherein the solvent comprises dimethylacetamide (DMAc).

15. The preparing method of claim 13, wherein in the filling the polycarbonate solution into pores of a nanocellulose film, the pores of the nanocellulose film is impregnated with the polycarbonate solution.
